(19) United States
(12) Patent Application Publication
(10) Pub. No.: US 2023/0108599 A1
(43) Pub. Date: Apr. 6, 2023

(54) METHOD AND SYSTEM FOR RATING APPLICANTS

(71) Applicant: Bank of Montreal, Toronto (CA)

(72) Inventor: Baiwu Zhang, Toronto (CA)

(73) Assignee: Bank of Montreal, Toronto (CA)

(21) Appl. No.: 17/492,520

(22) Filed: Oct. 1, 2021

(51) Int. Cl. G06Q 40/02; G06N 20/20; G06Q 30/02

(52) U.S. Cl. CPC G06Q 40/025; G06N 20/20; G06Q 30/0204

(57) ABSTRACT

An application selection system and method accesses a training dataset including historical application records, applicant records, and decision records. The system generates an inferred protected class dataset based upon applicant profile data, such as last name and postal code. The inferred protected class dataset may include one or more of race, color, religion, national origin, gender and sexual orientation. An algorithmic bias model inputs the training dataset and inferred protected class dataset to determine fairness metrics for decisions whether to approve an application. The fairness metrics may include demographic parity and equalized odds. The system adjusts an application selection model to mitigate algorithmic bias by increasing the fairness metrics for the decisions whether to approve an application. Measures for mitigating algorithmic bias may include removing discriminatory features; and determining a metric of disparate impact and adjusting the application selection model if the metric of disparate impact exceeds a predetermined limit.

### TECHNICAL FIELD

The present disclosure relates in general to computer-based methods and systems for mitigating algorithmic bias in predictive modeling, and more particularly for computer-based methods and systems for mitigating algorithmic bias in predicting eligibility for credit.

### BACKGROUND

A person or business (credit applicant) may seek a loan or credit approval from a lender or financial institution (creditor). Existing solutions allow for the credit applicant to access a credit application online, e.g., via the Internet. The credit applicant completes the credit application and then sends the completed credit application to the creditor. The creditor, in turn, receives the credit application, and evaluates financial and other information for the credit applicant and renders a report as to the applicant's credit eligibility. The creditor thereafter makes a decision as to whether to extend the loan or the credit to the credit applicant, and may decide terms governing extension of credit.

While various digital tools for have been developed to generate decisions whether to extend credit and on what terms, credit approval platforms can exhibit bias in algorithmic decision making against racial groups, religious groups, and other populations traditionally vulnerable to discrimination. Many aspects of fairness in lending are legally regulated in the United States, Canada, and other jurisdictions. Unintended bias in algorithmic decision making systems can affect individuals unfairly based on race, gender or religion, among other legally protected characteristics.

### SUMMARY

There is a need for systems and methods for algorithmic decision making in decisions whether to extend credit that avoid or mitigate algorithmic bias against racial groups, religious groups, and other populations traditionally vulnerable to discrimination. There is a need for tools to help system developers, financial analysts, and other users in checking algorithmic decision making systems for fairness and bias across a variety of metrics and use cases.

The methods and systems described herein attempt to address the deficiencies of conventional systems to more efficiently analyze applications to extend credit. In an embodiment, the predictive machine learning module incorporates techniques for avoiding or mitigating algorithmic bias against racial groups, ethnic groups, and other vulnerable populations.

An application selection system and method may access a training dataset including historical application records, applicant records, and decision records. The system may generate an inferred protected class dataset based upon applicant profile data, such as last name or postal code. The inferred protected class dataset may include one or more of race, color, religion, national origin, gender and sexual orientation. An algorithmic bias predictive model may input the training dataset and inferred protected class dataset to determine fairness metrics for decisions whether to approve an application. The fairness metrics may include demographic parity and equalized odds. The system may adjust an application selection model to mitigate algorithmic bias by increasing the fairness metrics for the decisions whether to approve an application. Measures for mitigating algorithmic bias may include removing discriminatory features, and determining a metric of disparate impact and adjusting the application selection model if the metric of disparate impact exceeds a predetermined limit.

A processor-based method for generating an inferred protected class dataset based upon applicant profile data may input the applicant profile data into a protected class demographic model. The protected class demographic model may be a classifier that relates the occurrence of certain applicant profile data to protected class demographic groups. The model may be trained via a supervised learning method on a training data set including applicant profile data. The processor may execute the trained protected class demographic model to determine whether to assign each applicant profile data instance to protected class demographic group. The processor may execute a multiclass classifier. The multiclass classifier returns class probabilities for the protected class demographic groups. For each applicant profile data instance assigned by the model to a protected class demographic group, the processor may calculate a confidence score.

In an embodiment, a method comprises accessing, by a processor, a training dataset for an application selection model comprising a plurality of historical application records, a plurality of applicant records each identified with an applicant of a respective historical application record, and a plurality of decision records each representing a decision whether to accept a respective historical application record; generating, by the processor, an inferred protected class dataset based upon applicant profile data in the plurality of applicant records; applying, by the processor, an algorithmic bias model to the training dataset and the inferred protected class dataset to determine fairness metrics for the decisions whether to accept the respective historical application records; and adjusting, by the processor, the application selection model to increase the fairness metrics for the decisions whether to accept the respective historical application records.

In another embodiment, a system comprises an applicant selection model; a non-transitory machine-readable memory that stores a training dataset for the applicant selection model comprised of a plurality of historical application records, a plurality of applicant records each identified with an applicant of a respective historical application record, and a plurality of decision records each representing a decision whether to accept a respective historical application record; and a processor, wherein the processor in communication with the applicant selection model and the non-transitory, machine-readable memory executes a set of instructions instructing the processor to: retrieve from the non-transitory machine-readable memory the training dataset for the applicant selection model comprised of the plurality of historical application records, the plurality of applicant records each identified with an applicant of the respective historical application record, and the plurality of decision records each representing a decision whether to accept the respective historical application record; generate an inferred protected class dataset based upon applicant profile data in the plurality of applicant records; apply an algorithmic bias model to the training dataset and the inferred protected class dataset to determine fairness metrics for the decisions whether to accept the respective historical application records; and adjust the application selection model to increase the fairness metrics for the decisions whether to accept the respective historical application records.

Numerous other aspects, features, and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a system architecture of a system for measuring and mitigating algorithmic bias in an applicant selection model, according to an embodiment.

FIG. 2 is a flow chart of a procedure for measuring and mitigating algorithmic bias in an applicant selection model, according to an embodiment.

FIG. 3 is a flow chart of a procedure for generating an inferred protected class dataset based upon applicant profile data, according to an embodiment.

### DETAILED DESCRIPTION

The present disclosure is herein described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

Described herein are computer-based systems and method embodiments that generate an inferred protected class dataset and employ this dataset in identifying fairness metrics for an application selection predictive model. The application selection predictive model may be a model for algorithmic review of an application for credit. As used herein, the phrase “predictive model” may refer to any class of algorithms that are used to understand relative factors contributing to an outcome, estimate unknown outcomes, discover trends, and/or make other estimations based on a data set of factors collected across prior trials. In an embodiment, the predictive model may refer to methods such as logistic regression, decision trees, neural networks, linear models, and/or Bayesian models.

An application selection system accesses a training dataset including historical application records, applicant records, and decision records. The system generates an inferred protected class dataset based upon applicant profile data, such as last name or postal code. The inferred protected class dataset may include one or more of race, color, religion, national origin, gender and sexual orientation. An algorithmic bias model inputs the training dataset and inferred protected class dataset to determine fairness metrics for decisions whether to approve an application. The fairness metrics may include demographic parity and equalized odds. The system adjusts an application selection model in order to mitigate algorithmic bias by increasing fairness metrics for a decision whether to approve an application. Techniques for mitigating algorithmic bias may include removing discriminatory features during model training. Techniques for mitigating algorithmic bias may include determining a metric of disparate impact, and adjusting the application selection model if the metric of disparate impact exceeds a predetermined limit during measurement of model performance.

Observable variables such as race, gender, nationality, ethnicity, age, religious affiliation, political leaning, sexual orientation, etc., may raise considerations other than appropriate indicators of credit eligibility, such as bias and discrimination. Populations traditionally vulnerable to bias in hiring include racial groups, ethnicities, women, older people, and young people, among others. In the United States and other jurisdictions across the world, when candidates are chosen on the basis of gender, race, religion, ethnicity, sexual orientation, disability, or other categories that are protected to some degree by law, penalties may be imposed for such practices. For example, various populations can correspond to protected classes in the U.S. under the Fair Credit Reporting Act (FCRA) and/or the Equal Employment Opportunity Commission (EEOC). Attributes of applicants for credit can include or correlate to protected class attributes and can form the basis for unintentional algorithmic bias. As will be further described in this disclosure, computer-based systems and method embodiments that model various metrics for credit approval are designed to avoid or mitigate algorithmic bias that can be triggered by such attributes. In an embodiment, model creation and training incorporates measures to ensure that applicant attributes are applied to provide realistic outcomes that are not tainted by unintentional bias relating to a protected class of the applicants.

Regulations implementing the Equal Credit Opportunity Act (ECOA) prohibit a creditor from inquiring about the race, color, religion, national origin, or sex of a credit applicant except under certain circumstances. Since information about membership of credit applicants in these demographic groups (protected classes) is generally not available in applicant profile data, disclosed embodiments determine inferred protected classes from other applicant attributes. These inferred demographic groups are applied to mitigate algorithmic bias that can be triggered by such attributes. Herein, attributes that are protected to some degree by law such as race, color, religion, national origin, gender and sexual orientation are sometimes referred to as protected class attributes.

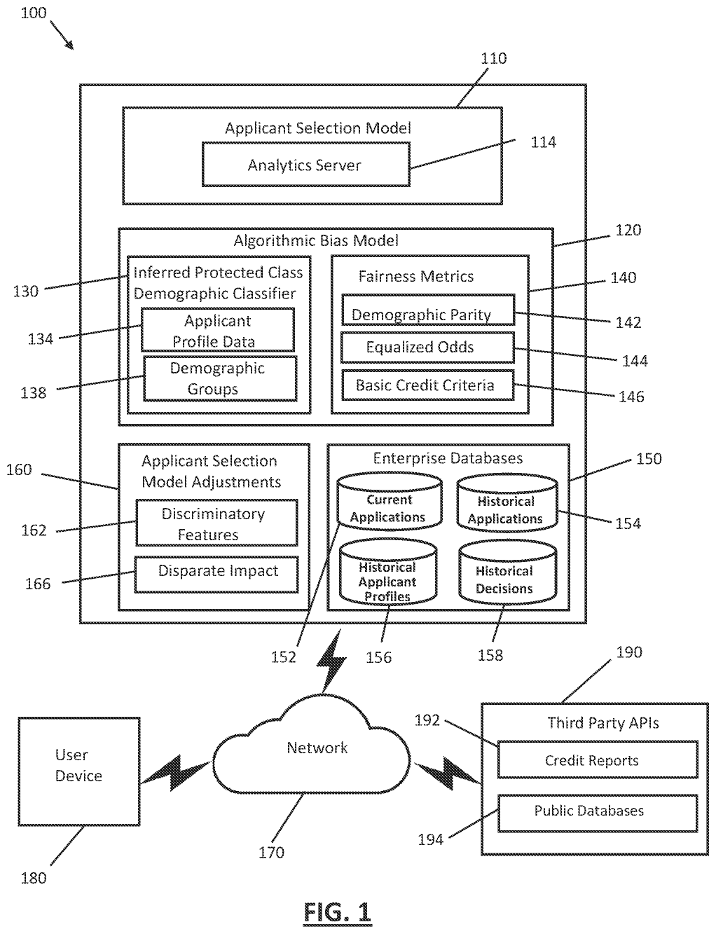

FIG. 1 shows a system architecture for a credit application system 100 incorporating an applicant selection model, also herein called credit approval system 100. Credit application system 100 may be hosted on one or more computers (or servers), and the one or more computers may include or be communicatively coupled to one or more databases. Credit application system 100 can effect predictive modeling of credit eligibility factors of applicants for credit. Attributes of applicants for credit can include or correlate to protected class attributes and can form the basis for unintentional algorithmic bias. Credit application system 100 incorporates an algorithmic bias model 120 and an applicant selection model adjustments module 160 designed to avoid or mitigate algorithmic bias that can be triggered by such attributes.

A sponsoring enterprise for credit application system 100 can be a bank or other financial services company, which may be represented by financial analysts, credit management professionals, loan officers, and other professionals. A user (customer or customer representative) can submit a digital application to credit application system 100 via user device 180. Digital applications received from user device 180 may be transmitted over network 170 and stored in current applications database 152 for processing by credit application system for algorithmic review via applicant selection model 110. In some embodiments, a user may submit a hard copy application for credit, which may be digitized and stored in current applications database 152.

In various embodiments, applicant selection model 110 outputs a decision as to whether an applicant is eligible for credit, and in some cases as to terms of credit. In some embodiments, applicant selection model may output recommendations for review and decision by professionals of the sponsoring enterprise. In either case, modules 120, 160 may be applied to the decision-making process to mitigate algorithmic bias and improve fairness metrics. In processing an electronic application submitted via user device 180, the system 100 can generate a report for the electronic application for display on a user interface on user device 180. In an embodiment, a report can include an explanation of a decision by applicant selection model 110, which explanation may include fairness metrics applied by the model.

The applicant selection model 110 may generate a score as an output. The score may be compared with a threshold to classify an application as eligible or ineligible for extension of credit. In an embodiment, the score may be compared with a first threshold and a lower second threshold to classify the application. In this embodiment, the model 110 may classify the application as eligible for credit of the score exceeds the first threshold, may classify the application as ineligible for credit if the score falls below the second threshold, and may classify the application for manual review if the score falls between the first and second thresholds. For certain categories of applicants associated with special loan programs such as student loans, the system 100 may apply special eligibility standards in making decisions on eligibility for credit.

Applicant selection model 110 includes an analytical engine 114. Analytical engine 114 executes thousands of automated rules encompassing, e.g., financial attributes, demographic data, employment history, credit scores, and other applicant profile data collected through digital applications and through third party APIs 190. Analytical engine 114 can be executed by a server, one or more server computers, authorized client computing devices, smartphones, desktop computers, laptop computers, tablet computers, PDAs and other types of processor-controlled devices that receive, process, and/or transmit digital data. Analytical engine 114 can be implemented using a single-processor system including one processor, or a multi-processor system including any number of suitable processors that may be employed to provide for parallel and/or sequential execution of one or more portions of the techniques described herein. Analytical engine 114 performs these operations as a result of central processing unit executing software instructions contained within a computer-readable medium, such as within memory. As used herein, a module may represent functionality (or at least a part of the functionality) performed by a server and/or a processor. For instance, different modules may represent different portion of the code executed by the analytical engine server 114 to achieve the results described herein. Therefore, a single server may perform the functionality described as being performed by separate modules.

In one embodiment, the software instructions of the system are read into memory associated with the analytical engine 114 from another memory location, such as from a storage device, or from another computing device via communication interface. In this embodiment, the software instructions contained within memory instruct the analytical engine 114 to perform processes described below. Alternatively, hardwired circuitry may be used in place of, or in combination with, software instructions to implement the processes described herein. Thus, implementations described herein are not limited to any specific combinations of hardware circuitry and software.

Enterprise databases 150 consist of various databases under custody of a sponsoring enterprise. In the embodiment of FIG. 1, enterprise databases 150 include current applications database 152, historical applications database 154, historical applicants profile data 156, and historical decisions database 158. Each record of the historical applicants profile database 156 may be identified with an applicant associated with a respective record in historical applications database 154. Each record of the historical decisions database 158 may represent a decision whether to accept a respective historical application, such as a decision whether or not to approve an application for credit. Enterprise databases 150 are organized collections of data, stored in non-transitory machine-readable storage. The databases may execute or may be managed by database management systems (DBMS), which may be computer software applications that interact with users, other applications, and the database itself, to capture (e.g., store data, update data) and analyze data (e.g., query data, execute data analysis algorithms). In some cases, the DBMS may execute or facilitate the definition, creation, querying, updating, and/or administration of databases. The databases may conform to a well-known structural representational model, such as relational databases, object-oriented databases, or network databases. Example database management systems include MySQL, PostgreSQL, SQLite, Microsoft SQL Server, Microsoft Access, Oracle, SAP, dBASE, FoxPro, IBM DB2, LibreOffice Base, and FileMaker Pro. Example database management systems also include NoSQL databases, i.e., non-relational or distributed databases that encompass various categories: key-value stores, document databases, wide-column databases, and graph databases.

Third party APIs 190 include various databases under custody of third parties. These databases may include credit reports 192 and public records 194 identified with the applicant for credit. Credit reports 192 may include information from credit bureaus such as EXPERIAN®, FICO®, EQUIFAX®, TransUnion®, and INNOVIS®. Credit information may include credit scores such as FICO® scores. Public records 194 may include various financial and non-financial data pertinent to eligibility for credit.

Applicant selection model 110 may include one or more machine learning predictive models. Suitable machine learning model classes include but are not limited to random forests, logistic regression methods, support vector machines, gradient tree boosting methods, nearest neighbor methods, and Bayesian regression methods. In an example, model training curated a data set of historical applications for credit 154, wherein the historical applications included then-current applicant profile data 156 of the applicants and decisions 158.

An algorithmic bias model 120 includes an inferred protected class demographic classifier 130 and fairness metrics module 140. During training of applicant selection model 110, the inferred protected class demographic classifier 130 generated an inferred protected class dataset based upon applicant profile data 156. The algorithmic bias model 120 applied a predictive machine learning model to a training dataset from databases 154, 156, and 158 and to the inferred protected class dataset to determine fairness metrics for decisions output by the applicant selection model 110. Applicant selection model adjustments module 160 adjusted the application selection model 110 to increase the fairness metrics for the decisions output by the applicant selection model 110.

Credit application system 100 and its components, such as applicant selection model 110, algorithmic bias model 120, and applicant selection model adjustments module 160, can be executed by a server, one or more server computers, authorized client computing devices, smartphones, desktop computers, laptop computers, tablet computers, PDAs, and other types of processor-controlled devices that receive, process and/or transmit digital data. System 100 can be implemented using a single-processor system including one processor, or a multi-processor system including any number of suitable processors that may be employed to provide for parallel and/or sequential execution of one or more portions of the techniques described herein. In an embodiment, system 100 performs these operations as a result of the central processing unit executing software instructions contained within a computer-readable medium, such as within memory. In one embodiment, the software instructions of the system are read into memory associated with the system 100 from another memory location, such as from storage device, or from another computing device via communication interface. In this embodiment, the software instructions contained within memory instruct the system 100 to perform processes described herein. Alternatively, hardwired circuitry may be used in place of or in combination with software instructions to implement the processes described herein. Thus, implementations described herein are not limited to any specific combinations of hardware circuitry and software.

Inferred protected class demographic classifier 130 is configured to generate an inferred protected class dataset based upon applicant profile data. In an embodiment, during training phase the inferred protected class dataset identifies a demographic group associated with a plurality of applicant profile records in historical applicant profile database 156. In various embodiments, the identified demographic group includes one or more protected class attributes, e.g., one or more of race, color, religion, national origin, gender and sexual orientation. In generating the inferred protected class dataset based upon applicant profile data, an input variable for inferred protected class classifier 130 may include last name of a person. In generating the inferred protected class dataset based upon applicant profile data, an input variable for inferred protected class classifier 130 may include a postal code identified with the applicant.

In an embodiment, the inferred protected class demographic classifier model 130 executes a multiclass classifier. Multiclass classification may employ batch learning algorithms. In an embodiment, the multiclass classifier employs multiclass logistic regression to return class probabilities for protected class demographic groups. In an embodiment, the classifiers predict that an applicant profile data instance belongs to a protected class demographic group if the classifier outputs a probability exceeding a predetermined threshold (e.g., >0.5),

An example inferred protected class demographic classifier model 130 incorporates a random forests framework in combination with regression framework. Random forests models for classification work by fitting an ensemble of decision tree classifiers on sub samples of the data. Each tree only sees a portion of the data, drawing samples of equal size with replacement. Each tree can use only a limited number of features. By averaging the output of classification across the ensemble, the random forests model can limit over-fitting that might otherwise occur in a decision tree model. The regression framework enables more efficient model development in dealing with hundreds of predictors and iterative feature selection. The predictive machine learning model can identify features that have the most pronounced impact on predicted value.

Algorithmic bias model 120 applies a machine learning model to the training dataset and the inferred protected class dataset to determine fairness metrics 140 for the decisions whether to accept the respective historical application records. In an embodiment, the algorithmic bias model applies a predictive machine learning model trained using features of the historical application records 154, the historical applicant profile records 156, and historical decision records 158.

In an embodiment, fairness metrics 140 include demographic parity 142. In an embodiment, demographic parity means that the proportion of each segment of a protected class receives a positive approval by model 110 at equal approval rates. Demographic parity 142 may include an approval rate and inferred protected class, ignoring other factors.

In an embodiment, fairness metrics 140 include a fairness metric for a credit score for each of the historical application records 152.

In an embodiment, fairness metrics 140 include equalized odds 144. As used in the present disclosure, equalized odds is satisfied if no matter whether an applicant is or is not a protected class, if they are qualified they are equally as likely to get approved, and if they are not qualified they are equally as likely to get rejected. Equalized odds may include an approval rate and inferred protected class for applicants satisfying predefined basic criteria 146 for approval. In an embodiment in which the application selection model outputs a decision whether to approve credit to an applicant, equalized odds are determined relative to applicants satisfying basic criteria 146 for credit eligibility.

Applicant selection model adjustments module 160 adjusts the application selection model 110 to increase the fairness metrics for the decisions output by the applicant selection model 110. In various embodiments, methods for developing and testing the credit approval system 100 incorporate applicant selection model adjustments 160 to mitigate algorithmic bias in predictive modeling. Mitigation measures taken prior to model training may include removing discriminatory features 162, screening features to include only features proven to correlate with target variables. In removing discriminatory features, seemingly unrelated variables can act as proxies for protected class. Biases may be present in the training data itself. Simply leaving out overt identifiers is not enough to avoid giving a model signal about race or marital status because this sensitive information may be encoded elsewhere. Measures for avoiding disparate impact include thorough examination of model variables and results, adjusting inputs and methods as needed.

In an embodiment, methods for mitigating algorithmic bias include data repair in building final datasets of the enterprise databases 150. Data repair seeks to remove the ability to predict the protected class status of an individual, and can effectively remove disparate impact 166. Data repair removes systemic bias present in the data, and is only applied to attributes used to make final decisions, not target variables. An illustrative data repair method repaired the data attribute by attribute. For each attribute, the method considered the distribution of the attribute, when conditioned on the applicants' protected class status, or proxy variable. If there was no difference in the distribution of the attribute when conditioned on the applicants' protected class status, the repair had no effect on the attribute.

In an embodiment, applicant selection model adjustments module 160 processes credit eligibility scores output by applicant selection model 110 to determine whether a metric of disparate impact exceeds a predetermined limit of relative selection rate to other groups in applicant selection system 100. In an embodiment, disparate impact component 166 identifies disparate impact using the ‘80% rule’ of the Equal Employment Opportunity Commission (EEOC). Disparate impact compares the rates of positive classification within protected groups, e.g., defined by gender or race. The ‘80% rule’ in employment states that the rate of selection within a protected demographic should be at least 80% of the rate of selection within the unprotected demographic. The quantity of interest in such a scenario is the ratio in positive classification outcomes for a protected group Y from the rest of the population X/Y. In an embodiment, in the event disparate impact component 166 determines that a metric of disparate impact exceeds the predetermined limit, module 160 sends a notification of this bias determination to enterprise users, and adjusts the applicant selection model 110 to improve this fairness metric.

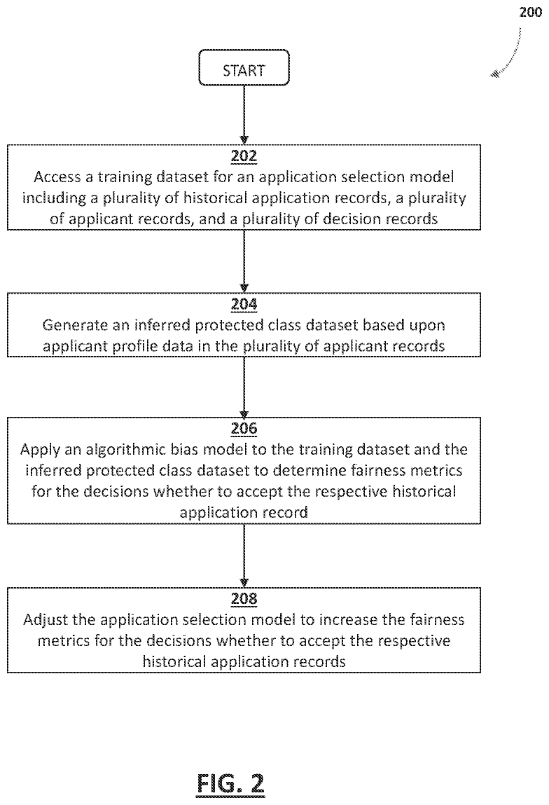

FIG. 2 illustrates a flow diagram of a procedure for measuring and mitigating algorithmic bias in an applicant selection model. The method 200 may include steps 202-208. However, other embodiments may include additional or alternative steps, or may omit one or more steps altogether.

The method 200 is described as being executed by a processor, such as the analytics server 114 described in FIG. 1. The analytics server may employ one or more processing units, including but not limited to CPUs, GPUs, or TPUs, to perform one or more steps of method 200. The CPUs, GPUs, and/or TPUs may be employed in part by the analytics server and in part by one or more other servers and/or computing devices. The servers and/or computing devices employing the processing units may be local and/or remote (or some combination). For example, one or more virtual machines in a cloud may employ one or more processing units, or a hybrid processing unit implementation, to perform one or more steps of method 200. However, one or more steps of method 200 may be executed by any number of computing devices operating in the distributed computing system described in FIG. 1. For instance, one or more computing devices may locally perform part or all of the steps described in FIG. 2.

In step 202, the processor accesses a training dataset for an application selection model including a plurality of historical application records, a plurality of applicant records, and a plurality of decision records. Each of the plurality of applicant records may be identified with an applicant of a respective historical application record. Each of the plurality of decision records may represent a decision whether to accept a respective historical application record.

In an embodiment of step 202, the application selection model is configured to output a decision whether to extend credit to an applicant. In this embodiment, the decision whether to accept the respective historical application record may include a decision whether to extend credit to the applicant of the respective historical application record.

In step 204, the processor generates an inferred protected class dataset based upon applicant profile data in the plurality of applicant records. In an embodiment, the inferred protected class dataset identifies a demographic group associated with each of the plurality of applicant records. In various embodiments, the identified demographic group includes one or more of race, color, religion, national origin, gender and sexual orientation.

In an embodiment of step 204, in generating the inferred protected class dataset based upon applicant profile data, the applicant profile data may include last name of a person. In generating the inferred protected class dataset based upon applicant profile data, the applicant profile data may include a postal code identified with the applicant.

In step 206, the processor applies an algorithmic bias model to the training dataset and the inferred protected class dataset to determine fairness metrics for the decisions whether to accept the respective historical application records. In an embodiment of step 206, the algorithmic bias model applies a predictive machine learning model trained using features of the historical application records and the applicant records.

In an embodiment of step 206, the fairness metrics for the decision whether to accept the respective historical application record include demographic parity. In an embodiment, demographic parity means that the proportion of each segment of a protected class receives a positive decision at equal approval rates. Demographic parity 142 may include an approval rate and inferred protected class, ignoring other factors.

The fairness metrics for the decision whether to extend credit may include a fairness metric for a credit score for each of the applicants of the respective historical application records.

In step 206 the fairness metrics for the decision whether to extend credit may include equalized odds. Equalized odds is satisfied provided that no matter whether an applicant is a protected class or is not in a protected class, if they are qualified, they are equally as likely to get approved, and if they are not qualified, they are equally as likely to get rejected. Equalized odds may include an approval rate and inferred protected class for applicants satisfying predefined basic criteria for approval. In an embodiment in which the application selection model outputs a decision whether to approve credit to an applicant, equalized odds are determined relative to applicants satisfying basic criteria for credit eligibility.

In step 208, the processor adjusts the application selection model to increase the fairness metrics for the decisions whether to accept the respective historical application records. Step 208 may adjust the applicant selection model via data repair in building final training datasets for the applicant selection model. In an embodiment in which the algorithmic bias model applies a predictive machine learning model trained using features of the historical application records and the applicant records, step 208 may adjust the application selection model via one or more of removing discriminatory features and screening features to include only features proven to correlate with target variables.

In an embodiment of step 208, during training of the applicant selection model, a model training procedure incorporates regularization to improve one or more fairness metrics in the trained model.

In an embodiment, the fairness metrics for the decisions whether to accept the respective historical application record include metrics of disparate impact. In an embodiment, step 206 determines a metric of disparate impact, and step 208 adjusts the application selection model if the metric of disparate impact exceeds a predetermined limit during measurement of model performance. In an embodiment, measures for mitigating algorithmic bias taken after model training include performance testing to test whether the model exhibits disparate impact.

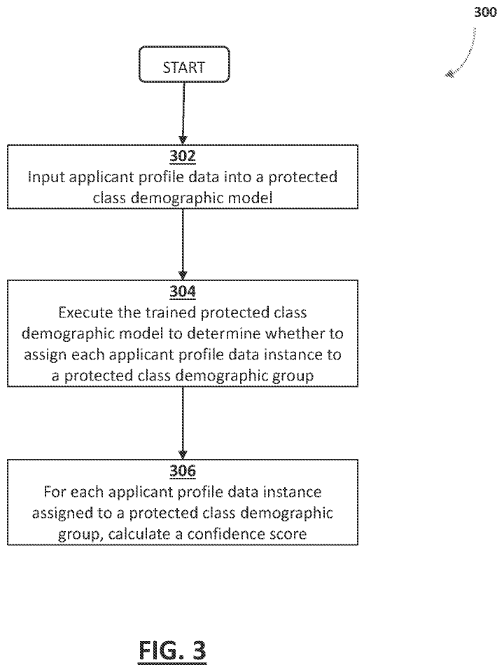

FIG. 3 illustrates a flow diagram of a processor-based method for generating an inferred protected class dataset based upon applicant profile data. The method 300 may include steps 302-306. However, other embodiments may include additional or alternative steps, or may omit one or more steps altogether.

At step 302, the processor inputs applicant profile data into a protected class demographic model. In an embodiment, the protected class demographic model is a classifier that relates the occurrence of certain applicant profile data to protected class demographic groups. In an embodiment, the protected class demographic model is a statistical machine learning predictive model. In an embodiment, the predictive model may refer to methods such as logistic regression, decision trees, neural networks, linear models, and/or Bayesian models.

In an embodiment, the model is trained via a supervised learning method on a training data set including applicant profile data. In an embodiment, the training data set includes pairs of an explanatory variable and an outcome variable, wherein the explanatory variable is a demographic feature from the applicant profile dataset, and the outcome variable is a protected class demographic group. In an embodiment, model fitting includes variable selection from the applicant profile dataset. The fitted model may be applied to predict the responses for the observations in a validation data set. In an embodiment, the validation dataset may be used for regularization to avoid over-fitting in the trained dataset.

At step 304, the processor executes the trained protected class demographic model to determine whether to assign each applicant profile data instance to protected class demographic group. In an embodiment of step 304, the processor executed a multiclass classifier. In an embodiment, multiclass classification employs batch learning algorithms. In an embodiment, the multiclass classifier employs multiclass logistic regression to return class probabilities for the protected class demographic groups. In an embodiment, the classifiers predict that an applicant profile data instance belongs to a protected class demographic group if the classifier outputs a probability exceeding a predetermined threshold (e.g., >0.5),

At step 306, for each applicant profile data instance assigned by the model to a protected class demographic group, the processor calculates a confidence score. In an embodiment, the protected class demographic model is multiclass classifier that returns class probabilities for the protected class demographic groups, and the confidence score is derived from the class probability for each applicant profile data instance assigned to a protected class demographic group.

The foregoing method descriptions and the interface configuration are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc., are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined here may be applied to other embodiments without departing from the spirit or scope of the invention. Thus, the present invention is not intended to be limited to the embodiments shown here but is to be accorded the widest scope consistent with the following claims and the principles and novel features disclosed here.

What is claimed is:

1. A method comprising:
accessing, by a processor, a training dataset for an application selection model comprising a plurality of historical application records, a plurality of applicant records each identified with an applicant of a respective historical application record, and a plurality of decision records each representing a decision whether to accept a respective historical application record;
generating, by the processor, an inferred protected class dataset based upon applicant profile data in the plurality of applicant records;
applying, by the processor, an algorithmic bias model to the training dataset and the inferred protected class dataset to determine fairness metrics for the decisions whether to accept the respective historical application records; and
adjusting, by the processor, the application selection model to increase the fairness metrics for the decisions whether to accept the respective historical application records.

2. The method of claim 1, wherein the inferred protected class dataset identifies a demographic group associated with each of the plurality of applicant records comprising one or more of race, color, religion, national origin, gender and sexual orientation.

3. The method of claim 1, wherein in generating the inferred protected class dataset based upon applicant profile data in the plurality of applicant records, the applicant profile data comprises last name of a person.

4. The method of claim 1, wherein in generating the inferred protected class dataset based upon applicant profile data in the plurality of applicant records, the applicant profile data comprises a postal code identified with the applicant.

5. The method of claim 1, wherein the algorithmic bias model applies a predictive machine learning model trained using features of the historical application records and the applicant records, wherein adjusting the application selection model comprises one or more of removing discriminatory features and screening features to include only features proven to correlate with target variables.

6. The method of claim 1, wherein adjusting the application selection model comprises determining a metric of disparate impact, and adjusting the application selection model if the metric of disparate impact exceeds a predetermined limit during measurement of model performance during measurement of model performance.

7. The method of claim 1, wherein the fairness metrics for the decision whether to accept the respective historical application record comprise demographic parity, including an approval rate and inferred protected class, ignoring other factors.

8. The method of claim 1, wherein the application selection model outputs a decision whether to extend credit to an applicant, wherein the decision whether to accept the respective historical application record comprises a decision whether to extend credit to the applicant of the respective historical application record.

9. The method of claim 8, wherein the fairness metrics for the decision whether to extend credit comprise a fairness metric for a credit score for each of the applicants of the respective historical application records.

10. The method of claim 8, wherein the fairness metrics for the decision whether to extend credit comprise equalized odds, including an approval rate and inferred protected class for applicants satisfying predefined basic criteria for which applicants are credit-worthy.

11. A system, comprising:
an applicant selection model;
a non-transitory machine-readable memory that stores a training dataset for the applicant selection model comprised of a plurality of historical application records, a plurality of applicant records each identified with an applicant of a respective historical application record, and a plurality of decision records each representing a decision whether to accept a respective historical application record; and
a processor, wherein the processor in communication with the applicant selection model and the non-transitory, machine-readable memory executes a set of instructions instructing the processor to:
retrieve from the non-transitory machine-readable memory the training dataset for the applicant selection model comprised of the plurality of historical application records, the plurality of applicant records each identified with an applicant of the respective historical application record, and the plurality of decision records each representing a decision whether to accept the respective historical application record;
generate an inferred protected class dataset based upon applicant profile data in the plurality of applicant records;
apply an algorithmic bias model to the training dataset and the inferred protected class dataset to determine fairness metrics for the decisions whether to accept the respective historical application records; and
adjust the application selection model to increase the fairness metrics for the decisions whether to accept the respective historical application records.

12. The system of claim 11, wherein the inferred protected class dataset identifies a demographic group associated with each of the plurality of applicant records comprising one or more of race, color, religion, national origin, gender and sexual orientation.

13. The method of claim 11, wherein in generating the inferred protected class dataset based upon applicant profile data in the plurality of applicant records, the applicant profile data comprises last name of a person.

14. The system of claim 11, wherein in generating the inferred protected class dataset based upon applicant profile data in the plurality of applicant records, the applicant profile data comprises a postal code identified with the applicant.

15. The system of claim 11, wherein the algorithmic bias model applies a predictive machine learning model trained using features of the historical application records and the applicant records, wherein adjusting the application selection model comprises one or more of removing discriminatory features and screening features to include only features proven to correlate with target variables.

16. The system of claim 11, wherein adjusting the application selection model comprises determining a metric of disparate impact, and adjusting the application selection model if the metric of disparate impact exceeds a predetermined limit during measurement of model performance.

17. The system of claim 11, wherein the fairness metrics for the decision whether to accept the respective historical application record comprise demographic parity, including an approval rate and inferred protected class, ignoring other factors.

18. The system of claim 11, wherein the application selection model outputs a decision whether to extend credit to an applicant, wherein the decision whether to accept the respective historical application record comprises a decision whether to extend credit to the applicant of the respective historical application record.

19. The system of claim 18, wherein the fairness metrics for the decision whether to extend credit comprise a fairness metric for a credit score for each of the applicants of the respective historical application records.

20. The system of claim 18, wherein the fairness metrics for the decision whether to extend credit comprise equalized odds, including an approval rate and inferred protected class for applicants satisfying predefined basic criteria for which applicants are credit-worthy.
